(19) United States
(12) Patent Application Publication
(10) Pub. No.: US 2015/0125594 A1
(43) Pub. Date: May 7, 2015

(54) FUEL CELL MEMBRANE ELECTRODE ASSEMBLY WITH MULTILAYER CATHODE

(71) Applicant: 3M INNOVATIVE PROPERTIES COMPANY, St. Paul, MN (US)

(72) Inventor: Andrew T. Haug, Woodbury, MN (US)

(73) Assignee: 3M INNOVATIVE PROPERTIES COMPANY

(21) Appl. No.: 14/596,482

(22) Filed: Jan. 14, 2015

Related U.S. Application Data
(62) Division of application No. 12/644,045, filed on Dec. 22, 2009.
(60) Provisional application No. 61/139,925, filed on Dec. 22, 2008.

(51) Int. Cl. H01M 8/10

(52) U.S. Cl. CPC H01M 8/1004; H01M 8/1018; H01M 2008/1095
USPC 427/115

(57) ABSTRACT

Polymer electrolyte membrane fuel cell membrane electrode assemblies are provided having multilayer cathodes, where a first layer of the cathode which is more proximate to the polymer electrolyte membrane is more hydrophilic than a second more distal layer of the cathode. In some embodiments, the first layer includes a polymer electrolyte having a lower equivalent weight than a polymer electrolyte included in the second layer.

### CROSS REFERENCE TO RELATED APPLICATIONS

This application is a divisional of U.S. application Ser. No. 12/644,045, filed Dec. 22, 2009, now pending, which claims the benefit of U.S. Provisional Patent Application No. 61/139,925, filed Dec. 22, 2008, the disclosures of which are incorporated by reference herein in their entireties.

### FIELD OF THE DISCLOSURE

This disclosure relates to polymer electrolyte membrane fuel cell membrane electrode assemblies having multilayer cathodes, where a first layer of the cathode which is more proximate to the polymer electrolyte membrane is more hydrophilic than a second layer of the cathode, the second layer being more distal to the polymer electrolyte membrane.

### SUMMARY OF THE DISCLOSURE

Briefly, the present disclosure provides a fuel cell membrane electrode assembly comprising: i) a polymer electrolyte membrane having first and second faces; ii) an anode catalyst layer borne on the first face of the polymer electrolyte membrane; iii) a first cathode catalyst layer borne on the second face of the polymer electrolyte membrane, the first cathode catalyst layer comprising a first cathode catalyst material and a first polymer electrolyte; and iv) a second cathode catalyst layer borne on the first cathode catalyst layer, the second cathode catalyst layer comprising a second cathode catalyst material and a second polymer electrolyte; wherein the first cathode catalyst layer is more hydrophilic than the second cathode catalyst layer. In some embodiments, the first polymer electrolyte has a first equivalent weight, the second polymer electrolyte has a second equivalent weight, and first equivalent weight is less than the second equivalent weight, typically less than 85% of the second equivalent weight, and in some embodiments less than 70% of the second equivalent weight. In some embodiments the first equivalent weight is 1050 or less, more typically 1000 or less, more typically 950 or less, more typically 900 or less, more typically 850 or less, and most typically 800 or less. Typically, the first cathode catalyst layer is immediately adjacent to the second face of the polymer electrolyte membrane. Typically, the second cathode catalyst layer is immediately adjacent to the first cathode catalyst layer. Typically the ratio of the weight of the first cathode catalyst material to the weight of the second cathode catalyst material is between 1:4 and 4:1, and more typically between 1:2 and 2:1. Typically the first and second polymer electrolytes are highly fluorinated and more typically perfluorinated. The first and second polymer electrolytes may comprise pendent groups according to the formula: —O—CF₂—CF₂—CF₂—CF₂—SO₃H.

In another aspect, the present disclosure provides a method of making a fuel cell membrane electrode assembly comprising the steps of: i) providing a polymer electrolyte membrane having first and second faces; ii) applying a first cathode catalyst layer to the second face of the polymer electrolyte membrane, the first cathode catalyst layer comprising a first cathode catalyst material and a first polymer electrolyte having a first equivalent weight; and iii) applying a second cathode catalyst layer to the first cathode catalyst layer, the second cathode catalyst layer comprising a second cathode catalyst material and a second polymer electrolyte having a second equivalent weight; wherein the first cathode catalyst layer is more hydrophilic than the second cathode catalyst layer. In some embodiments the method may additionally comprise the step of: iv) applying the second cathode catalyst layer to a gas diffusion layer to make a catalyst-coated backing prior to step iii); and wherein step iii) comprises applying the catalyst-coated backing to the first cathode catalyst layer. In some embodiments the method may additionally comprise the step of: v) applying an anode catalyst layer to the first face of the polymer electrolyte membrane. In some embodiments of the method, the first equivalent weight is less than the second equivalent weight, typically less than 85% of the second equivalent weight, and in some embodiments less than 70% of the second equivalent weight. In some embodiments the first equivalent weight is 1050 or less, more typically 1000 or less, more typically 950 or less, more typically 900 or less, more typically 850 or less, and most typically 800 or less. Typically, the first cathode catalyst layer is immediately adjacent to the second face of the polymer electrolyte membrane. Typically, the second cathode catalyst layer is immediately adjacent to the first cathode catalyst layer. Typically the ratio of the weight of the first cathode catalyst material to the weight of the second cathode catalyst material is between 1:4 and 4:1, and more typically between 1:2 and 2:1. Typically the first and second polymer electrolytes are highly fluorinated and more typically perfluorinated. The first and second polymer electrolytes may comprise pendent groups according to the formula: —O—CF₂—CF₂—CF₂—CF₂—SO₃H.

In another aspect, the present disclosure provides a method of making a fuel cell membrane electrode assembly comprising the steps of: i) providing a polymer electrolyte membrane having first and second faces; ii) providing a gas diffusion layer having a face; iii) applying a second cathode catalyst layer to the face of the gas diffusion layer, the second cathode catalyst layer comprising a second cathode catalyst material and a second polymer electrolyte having a second equivalent weight; iv) applying a first cathode catalyst layer to the second cathode catalyst layer, the first cathode catalyst layer comprising a first cathode catalyst material and a first polymer electrolyte having a first equivalent weight; wherein the first cathode catalyst layer is more hydrophilic than the second cathode catalyst layer. In some embodiments the method may additionally comprise the step of: v) applying an anode catalyst layer to the first face of the polymer electrolyte membrane. In some embodiments of the method, the first equivalent weight is less than the second equivalent weight, typically less than 85% of the second equivalent weight, and in some embodiments less than 70% of the second equivalent weight. In some embodiments the first equivalent weight is 1050 or less, more typically 1000 or less, more typically 950 or less, more typically 900 or less, more typically 850 or less, and most typically 800 or less. Typically, the first cathode catalyst layer is immediately adjacent to the second face of the polymer electrolyte membrane. Typically, the second cathode catalyst layer is immediately adjacent to the first cathode catalyst layer. Typically the ratio of the weight of the first cathode catalyst material to the weight of the second cathode catalyst material is between 1:4 and 4:1, and more typically between 1:2 and 2:1. Typically the first and second polymer electrolytes are highly fluorinated and more typically perfluorinated. The first and second polymer electrolytes may comprise pendent groups according to the formula: —O—CF₂—CF₂—CF₂—CF₂—SO₃H.

In this application:

“equivalent weight” (EW) of a polymer means the weight of polymer which will neutralize one equivalent of base;

“highly fluorinated” means containing fluorine in an amount of 40 wt % or more, typically 50 wt % or more and more typically 60 wt % or more.

### BRIEF DESCRIPTION OF THE DRAWING

FIG. 1 is a graph of polarization curves for an MEA according to the present disclosure after repeated start-up/shut-down cycles, as described in the Examples. Each curve is labeled with the number of start-up/shut-down cycles undergone before the curve was measured.

FIG. 2 is a graph of polarization curves for a Comparative MEA after repeated start-up/shut-down cycles, as described in the Examples. Each curve is labeled with the number of start-up/shut-down cycles undergone before the curve was measured.

### DETAILED DESCRIPTION

The present disclosure provides a fuel cell membrane electrode assembly having a multilayer cathode which may demonstrate good performance over a wide range of operating conditions.

The membrane electrode assembly (MEA) according to the present disclosure may be used in fuel cells. An MEA is the central element of a proton exchange membrane fuel cell, such as a hydrogen fuel cell. Fuel cells are electrochemical cells which produce usable electricity by the catalyzed combination of a fuel such as hydrogen and an oxidant such as oxygen. Typical MEA's comprise a polymer electrolyte membrane (PEM) (also known as an ion conductive membrane (ICM)) which functions as a solid electrolyte. One face of the PEM is in contact with an anode electrode layer and the opposite face is in contact with a cathode electrode layer. In typical use, protons are formed at the anode via hydrogen oxidation and transported across the PEM to the cathode to react with oxygen, causing electrical current to flow in an external circuit connecting the electrodes. Each electrode layer includes electrochemical catalysts, typically including platinum metal. The PEM forms a durable, non-porous, electrically non-conductive mechanical barrier between the reactant gases, yet it also passes H⁺ ions readily. Gas diffusion layers (GDL's) facilitate gas transport to and from the anode and cathode electrode materials and conduct electrical current. The GDL is both porous and electrically conductive, and is typically composed of carbon fibers. The GDL may also be called a fluid transport layer (FTL) or a diffuser/current collector (DCC). In some embodiments, the anode and cathode electrode layers are applied to GDL's and the resulting catalyst-coated GDL's sandwiched with a PEM to form a five-layer MEA. The five layers of a five-layer MEA are, in order: anode GDL, anode electrode layer, PEM, cathode electrode layer, and cathode GDL. In other embodiments, the anode and cathode electrode layers are applied to either side of the PEM, and the resulting catalyst-coated membrane (CCM) is sandwiched between two GDL's to form a five-layer MEA.

PEM's useful in the MEA's according to the present disclosure may comprise any suitable polymer electrolyte. The polymer electrolytes useful in the present disclosure typically bear anionic functional groups bound to a common backbone, which are typically sulfonic acid groups but may also include carboxylic acid groups, imide groups, amide groups, or other acidic functional groups. The polymer electrolytes useful in the present disclosure are typically highly fluorinated and most typically perfluorinated, but may also be partially fluorinated or non-fluorinated. The polymer electrolytes useful in the present disclosure are typically copolymers of tetrafluoroethylene and one or more fluorinated, acid-functional comonomers. Typical polymer electrolytes include Nafion® (DuPont Chemicals, Wilmington Del.) and Flemion™ (Asahi Glass Co. Ltd., Tokyo, Japan). The polymer electrolyte may be a copolymer of tetrafluoroethylene (TFE) and FSO₂—CF₂CF₂CF₂CF₂—O—CF═CF₂, described in U.S. patent application Ser. Nos. 10/322,254, 10/322,226 and 10/325,278, which are incorporated herein by reference. The polymer typically has an equivalent weight (EW) of 1200 or less, more typically 1100 or less, more typically 1050 or less, more typically 1000 or less, and in some embodiments 950 or less, 900 or less, 850 or less, or 800 or less. In addition to fluorinated membranes, membranes useful in the present disclosure may include hydrocarbon polymers, including aromatic polymers. Examples of useful hydrocarbon polymers may include sulfonated polyetheretherketones, sulfonated polysulfones and sulfonated polystyrenes.

The polymer can be formed into a membrane by any suitable method. The polymer is typically cast from a suspension. Any suitable casting method may be used, including bar coating, spray coating, slit coating, brush coating, and the like. Alternately, the membrane may be formed from neat polymer in a melt process such as extrusion. After forming, the membrane may be annealed, typically at a temperature of 120° C. or higher, more typically 130° C. or higher, most typically 150° C. or higher. The PEM typically has a thickness of less than 50 microns, more typically less than 40 microns, more typically less than 30 microns, and most typically about 25 microns.

In one embodiment of the present disclosure, a salt or oxide of manganese or cerium, more typically a salt, more typically manganese, is added to the acid form polymer electrolyte prior to membrane formation. Typically the salt is mixed well with or dissolved within the polymer electrolyte to achieve substantially uniform distribution. The salt may comprise any suitable anion, including chloride, bromide, nitrate, carbonate and the like. Once cation exchange occurs between the transition metal salt and the acid form polymer, it may be desirable for the acid formed by combination of the liberated proton and the original salt anion to be removed. Thus, it may be preferred to use anions that generate volatile or soluble acids, for example chloride or nitrate. Manganese cations may be in any suitable oxidation state, including Mn²⁺, Mn³⁺ and Mn⁴⁺, but are most typically Mn²⁺. The amount of salt added is typically between 0.001 and 0.5 charge equivalents based on the molar amount of acid functional groups present in the polymer electrolyte, more typically between 0.005 and 0.2, more typically between 0.01 and 0.1, and more typically between 0.02 and 0.05.

Any suitable catalyst may be used in the practice of the present disclosure. Typically, carbon-supported catalyst particles are used. Typical carbon-supported catalyst particles are 50-90% carbon and 10-50% catalyst metal by weight, the catalyst metal typically comprising Pt for the cathode and Pt and Ru in a weight ratio of 2:1 for the anode. Typically, the catalyst is applied to the PEM or to the GDL in the form of a catalyst ink. Alternately, the catalyst ink may be applied to a transfer substrate, dried, and thereafter applied to the PEM or to the GDL as a decal. The catalyst ink typically comprises polymer electrolyte material, which may or may not be the same polymer electrolyte material which comprises the PEM. The catalyst ink typically comprises a dispersion of catalyst particles in a dispersion of the polymer electrolyte. In some embodiments of the present disclosure, a salt or oxide of manganese or cerium, more typically an oxide, more typically of cerium, is added to the polymer electrolyte prior to membrane formation. The ink typically contains 5-30% solids (i.e. polymer and catalyst) and more typically 10-20% solids. The electrolyte dispersion is typically an aqueous dispersion, which may additionally contain alcohols and polyalcohols such a glycerin and ethylene glycol. The water, alcohol, and polyalcohol content may be adjusted to alter rheological properties of the ink. The ink typically contains 0-50% alcohol and 0-20% polyalcohol. In addition, the ink may contain 0-2% of a suitable dispersant. The ink is typically made by stirring with heat followed by dilution to a coatable consistency.

To make an MEA or CCM, catalyst may be applied to the PEM by any suitable means, including both hand and machine methods, including hand brushing, notch bar coating, fluid bearing die coating, wire-wound rod coating, fluid bearing coating, slot-fed knife coating, three-roll coating, or decal transfer. Coating may be achieved in one application or in multiple applications.

To make an MEA, GDL's may be applied to either side of a CCM by any suitable means. Any suitable GDL may be used in the practice of the present disclosure. Typically the GDL is comprised of sheet material comprising carbon fibers. Typically the GDL is a carbon fiber construction selected from woven and non-woven carbon fiber constructions. Carbon fiber constructions which may be useful in the practice of the present disclosure may include: Toray™ Carbon Paper, SpectraCarb™ Carbon Paper, AFN™ non-woven carbon cloth, Zoltek™ Carbon Cloth, and the like. The GDL may be coated or impregnated with various materials, including carbon particle coatings, hydrophilizing treatments, and hydrophobizing treatments such as coating with polytetrafluoroethylene (PTFE).

In some embodiments, catalyst may be applied to a GDL to make a catalyst-coated backing (CCB) and CCB's may then be combined with a PEM to make an MEA. In such embodiments, catalyst may be applied to the GDL by any suitable means, including both hand and machine methods, including hand brushing, notch bar coating, fluid bearing die coating, wire-wound rod coating, fluid bearing coating, slot-fed knife coating, three-roll coating, or decal transfer. Coating may be achieved in one application or in multiple applications.

The cathode catalyst of the MEA according to the present disclosure comprises two or more layers, where a first layer of the cathode which is more proximate to the polymer electrolyte membrane is more hydrophilic than a second layer of the cathode, the second layer being more distal to the polymer electrolyte membrane. In some embodiments, the first cathode catalyst layer is borne on a face of the polymer electrolyte membrane and the second cathode catalyst layer is borne on the first cathode catalyst layer. Typically, the first cathode catalyst layer is immediately adjacent to the polymer electrolyte membrane. Typically, the second cathode catalyst layer is immediately adjacent to the first cathode catalyst layer. In some embodiments the cathode catalyst of the present disclosure may include additional layers interposed between the PEM, first cathode catalyst layer and/or second cathode catalyst layer. In some embodiments the cathode catalyst of the present disclosure may include one or more layers having intermediate hydrophilicity interposed between the first cathode catalyst layer and the second cathode catalyst layer. In some embodiments the cathode catalyst of the present disclosure may include one layer having intermediate hydrophilicity interposed between the first cathode catalyst layer and the second cathode catalyst layer. In some embodiments the cathode catalyst of the present disclosure includes only two layers, the first cathode catalyst layer and the second cathode catalyst layer.

In some embodiments, the first cathode catalyst layer comprises a first cathode catalyst material and a first polymer electrolyte and the second cathode catalyst layer comprises a second cathode catalyst material and a second polymer electrolyte. Any suitable catalyst materials and polymer electrolytes may be used in the two layers, which may be the same or different, except that the first cathode catalyst layer is more hydrophilic than the second cathode catalyst layer. Typically the ratio of the weight of the first cathode catalyst material to the weight of the second cathode catalyst material is between 1:4 and 4:1, and more typically between 1:2 and 2:1. In some embodiments, the first polymer electrolyte has a first equivalent weight, the second polymer electrolyte has a second equivalent weight, and first equivalent weight is less than the second equivalent weight, typically less than 95% of the second equivalent weight, more typically less than 90% of the second equivalent weight, more typically less than 85% of the second equivalent weight, more typically less than 80% of the second equivalent weight, more typically less than 75% of the second equivalent weight, and in some embodiments less than 70% of the second equivalent weight. In some embodiments the first equivalent weight is 1050 or less, more typically 1000 or less, more typically 950 or less, more typically 900 or less, more typically 850 or less, and most typically 800 or less. Typically the first and second polymer electrolytes are highly fluorinated and more typically perfluorinated. The first and second polymer electrolytes may comprise pendent groups according to the formula: —O—CF₂—CF₂—CF₂—CF₂—SO₃H.

In some embodiments, the first and second catalyst layers comprise differing amounts of hydrophilizing additives. In some embodiments, the first and second catalyst layers comprise differing amounts of hydrophobizing additives. In some embodiments, the first catalyst layer comprises hydrophilizing additives and the second catalyst layer comprises hydrophobizing additives.

The MEA according to the present disclosure may be made by any suitable method. In some embodiments of such methods, a first cathode catalyst layer is applied to a face of a polymer electrolyte membrane and a second cathode catalyst layer is thereafter applied to the first cathode catalyst layer. A gas diffusion layer may then be applied to the catalyst. In some embodiments of such methods, a second cathode catalyst layer is applied to the first cathode catalyst layer and the two-layer cathode is thereafter applied to a face of a polymer electrolyte membrane, so as to apply the first cathode catalyst layer to the face of the polymer electrolyte membrane. A gas diffusion layer may then be applied over the catalyst. In some embodiments of such methods, a first cathode catalyst layer is applied to a face of a polymer electrolyte membrane to make a catalyst-coated membrane (CCM), a second cathode catalyst layer is applied to a gas diffusion layer to make a catalyst-coated backing (CCB), and thereafter the CCB is applied to the CCM so as to apply the second cathode catalyst layer to the first cathode catalyst layer. In some embodiments of such methods, a second cathode catalyst layer is applied to a gas diffusion layer and a first cathode catalyst layer is applied to the second cathode catalyst layer, making a catalyst-coated backing (CCB), and the CCB is then applied to a face of a polymer electrolyte membrane so as to apply the first cathode catalyst layer to the face of the polymer electrolyte membrane. In some embodiments of such methods, a second cathode catalyst layer is applied to the first cathode catalyst layer and the two-layer cathode is thereafter applied to a face of a gas diffusion layer (GDL) so as to apply the second cathode catalyst layer to the GDL, making a catalyst-coated backing (CCB), and the CCB is then applied to a face of a polymer electrolyte membrane so as to apply the first cathode catalyst layer to the face of the polymer electrolyte membrane.

In any of the foregoing embodiments the method may additionally comprise the step of applying an anode catalyst layer and anode-side GDL to an opposite face of the polymer electrolyte membrane to complete the five-layer MEA.

In use, the MEA according to the present typically sandwiched between two rigid plates, known as distribution plates, also known as bipolar plates (BPP's) or monopolar plates. Like the GDL, the distribution plate must be electrically conductive. The distribution plate is typically made of a carbon composite, metal, or plated metal material. The distribution plate distributes reactant or product fluids to and from the MEA electrode surfaces, typically through one or more fluid-conducting channels engraved, milled, molded or stamped in the surface(s) facing the MEA(s). These channels are sometimes designated a flow field. The distribution plate may distribute fluids to and from two consecutive MEA's in a stack, with one face directing fuel to the anode of the first MEA while the other face directs oxidant to the cathode of the next MEA (and removes product water), hence the term “bipolar plate.” Alternately, the distribution plate may have channels on one side only, to distribute fluids to or from an MEA on only that side, which may be termed a “monopolar plate.” The term bipolar plate, as used in the art, typically encompasses monopolar plates as well. A typical fuel cell stack comprises a number of MEA's stacked alternately with bipolar plates.

Objects and advantages of this invention are further illustrated by the following examples, but the particular materials and amounts thereof recited in these examples, as well as other conditions and details, should not be construed to unduly limit this invention.

### Examples

Unless otherwise noted, all reagents were obtained or are available from Aldrich Chemical Co., Milwaukee, Wis., or may be synthesized by known methods.

### Ionomer Preparation

The ionomer used in catalyst inks and membranes in each of the following Examples and Comparative Examples is a copolymer of tetrafluoroethylene (TFE) and FSO₂—CF₂CF₂CF₂CF₂—O—CF═CF₂ (Comonomer A). Comonomer A was made according to the procedures disclosed in U.S. patent application Ser. Nos. 10/322,254 and 10/322,226, incorporated herein by reference. Polymerization was performed by aqueous emulsion polymerization as described in U.S. patent application Ser. No. 10/325,278. The equivalent weight (EW) of the ionomer was 800, 1000 or 1200 as indicated.

### Membrane Preparation

Polymer electrolyte membranes (PEM's) were made from the 800 EW ionomer. The ionomer used in membrane preparation was provided in a casting solution containing 22.3% solids in 70:30 n-propanol/water. Manganese nitrate Mn(NO₃)₂ was added to the casting solution in an amount equal to 0.035 charge equivalents based on the molar amount of anionic functional groups present in the polymer electrolyte in accord with the procedures disclosed in U.S. patent application Ser. No. 10/945,178, incorporated herein by reference.

Membranes were cast at a wet thickness of about 400 to 500 microns, onto a substrate of either PET (polyethylene terphthalate) or Kapton (polyimide). These castings were dried at 80-100° C., and then annealed at 160-200° C. for about 3 to 5 minutes. After cooling, the membranes were peeled form the liner and used without further purification. Final membrane thickness was 0.8 mil (20 microns).

### MEA Preparation

Membrane electrode assemblies (MEA's) having 50 cm² of active area were made by addition of a catalyst coated backing (CCB), which is a gas diffusion layer (GDL) coated with catalyst ink, to opposite faces of the PEM followed by addition of a gasket to each face, as detailed following.

Catalyst inks were made by ball milling a carbon-supported platinum catalyst (30 wt % Pt supported on Vulcan® XC72, designated 10V30E, manufactured by Tanaka Kikinzoku, Tokyo, Japan) with ionomer and water in an ionomer/catalyst ratio of 0.8 by weight and a solids content of 20% by weight. The 1000EW ionomer was used for all anode catalyst inks.

GDL's were made by applying a microporous PTFE suspension to a non-woven carbon fiber paper followed by application of a carbon particle-polytetrofluoroethylene microporous layer (MPL), as disclosed in U.S. patent application Ser. No. 11/092,017, the disclosure of which is incorporated herein by reference.

Anode catalyst inks were hand-painted on one face of a GDL at a loading of 0.1 mg Pt/cm² to make anode CCB's. Cathode catalyst inks were hand-painted on one face of a GDL to make cathode CCB's. For Comparative Example 1, the cathode catalyst ink was applied in a single layer of a single ink made with 800EW ionomer at a loading of 0.3 mg Pt/cm². For Comparative Example 2, the cathode catalyst ink was applied in a single layer of a single ink made with 1200EW ionomer at a loading of 0.3 mg Pt/cm². For Comparative Example 3, the cathode catalyst ink was applied in a single layer of a single ink made with 1000EW ionomer at a loading of 0.3 mg Pt/cm². For Example 1 of the present disclosure, the cathode catalyst ink was applied in two layers, the first being an ink made with 1200EW ionomer at a loading of 0.15 mg Pt/cm² and the second (which was immediately adjacent to the PEM in the MEA) being an ink made with 800EW ionomer at a loading of 0.15 mg Pt/cm², for a total loading of 0.3 mg Pt/cm². After application of catalyst inks, the resulting CCB's were annealed in a vacuum oven for 30 minutes at 150° C. and 7 psi pressure (absolute).

CCB's and polytetrafluoroethylene/glass composite gaskets were applied to the PEM by pressing in a Carver Press (Fred Carver Co., Wabash, Ind.) with 13.4 kN of force at 132° C. for 10 minutes.

### Performance Evaluation

MEA's of Example 1 and Comparative Examples 1 and 2 were mounted in a test cell station (Fuel Cell Technologies, Inc., Albuquerque, N. Mex.). The test station includes a variable electronic load with separate anode and cathode gas handling systems to control gas flow, pressure, and humidity. The electronic load and gas flows are computer controlled. Fuel cell polarization curves were obtained under the following test parameters: electrode area of 50 cm²; anode gas pressure of 0 psig; anode stiochiometric flow rate 1.7 (i.e. 1.7 times the moles of gas required to produce the desired electric current); cathode gas pressure of 0 psig; cathode stiochiometric flow rate 2.5. Humidification of the cathode and anode was provided by steam injection (injector temperature of 120° C.). Operating temperature and relative humidity (RH) were controlled as indicated below.

The performance of the MEA's of Comparative Examples 1 and 2 and Example 1 were evaluated under three different sets of conditions for operating temperature and relative humidity (RH) of the inlet gases:
1. 30° C., 100% RH, 0.6 A/cm²—cold and wet conditions, where significant liquid water is present and cathode flooding can occur.
2. 55° C., 100% RH, 0.8 A/cm²—optimal operating conditions.
3. 80° C., 0% RH, 0.6 A/cm²—hot and dry conditions, where the cathode must retain water to perform well.

The cell voltage was measured at the indicated current (0.6 A/cm² or 0.8 A/cm²) for three repetitions of each test, performed for each of the three types of MEA under each of the three sets of conditions. Table I reports the average values obtained over three repetitions of each test.

TABLE I

| | Condition 1 | Condition 2 | Condition 3 |
|---|---|---|---|
| | (cold and wet) | (optimal) | (hot and dry) |
| Comparative Ex. 1 | 0.0 V | 0.57 V | 0.60 V |
| (800EW) | | | |
| Comparative Ex. 2 | 0.59 V | 0.61 V | 0.29 V |
| (1200EW) | | | |
| Example 1 (layered | 0.55 V | 0.60 V | 0.59 V |
| cathode) | | | |

It can readily be seen that the MEA of Comparative Example 1 underperformed under cold and wet conditions and the MEA of Comparative Example 2 underperformed under hot and dry conditions. In contrast, the MEA according to the present disclosure performed well under all three sets of conditions.

### Durability Evaluation

MEA's of Example 1 and Comparative Example 3 were tested for durability under conditions of repeated start-stop cycling in order to evaluate durability.

Start-stop cycling is a phenomenon that occurs in fuel cells, typically during start-up and shutdown procedures, which can result in significant carbon corrosion of the cathode catalyst, which in turn can result in significant loss of fuel cell performance. A typical cycle begins with fuel (typically hydrogen) flowing to the fuel cell anode and air flowing to the cathode in a continuous manner. The shut-down portion of the cycle occurs when the fuel flow is replaced with air flow on the anode side. During this transition of gases, both fuel and air may be present in the anode as air pushes out the remaining fuel. During this transition, cathode potentials may rise to greater than 1.4V, a voltage at which significant carbon oxidation may occur. Eventually air is present on both the fuel and air sides of the fuel cell, dropping the cell voltage to zero while electrode potentials remain at 1 to 1.2V.

Cell start-up occurs in a similar fashion. Air exists on both anode and cathode sides of the membrane. Fuel is then introduced to the anode flowchannels, creating a transition period in which fuel and air exist on the anode side. During this start-up transition, cathode potentials may rise to greater than 1.4V, creating the conditions for significant carbon oxidation to occur. Eventually all air is removed from the anode side and cell voltages return to normal open circuit values of 0.9 to 1.0V, while anode potentials return to 0V and cathode potentials return to 0.9 to 1.0V.

MEA's of Example 1 and Comparative Example 3 were mounted in a test cell station (Fuel Cell Technologies, Inc., Albuquerque, N. Mex.). The test station includes a variable electronic load with separate anode and cathode gas handling systems to control gas flow, pressure, and humidity. The electronic load and gas flows are computer controlled. Fuel cell polarization curves were obtained under the following test parameters: electrode area of 50 cm²; anode gas pressure of 0 psig; anode stiochiometric flow rate 1.7 (i.e. 1.7 times the moles of gas required to produce the desired electric current); cathode gas pressure of 0 psig; cathode stiochiometric flow rate 2.5. Operating temperature and relative humidity (RH) of the inlet gases were 40° C. and 100% RH. Humidification of the cathode and anode was provided by steam injection (injector temperature of 120° C.). MEA's were subjected to repeated start-up/shut-down cycles and polarization curves were measured every 5 cycles.

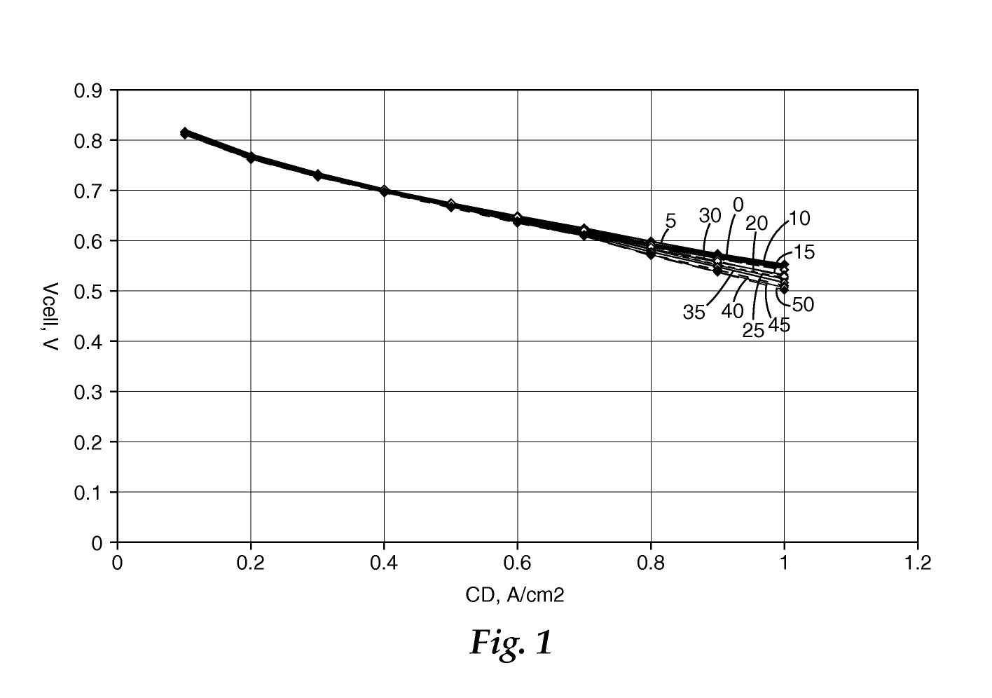

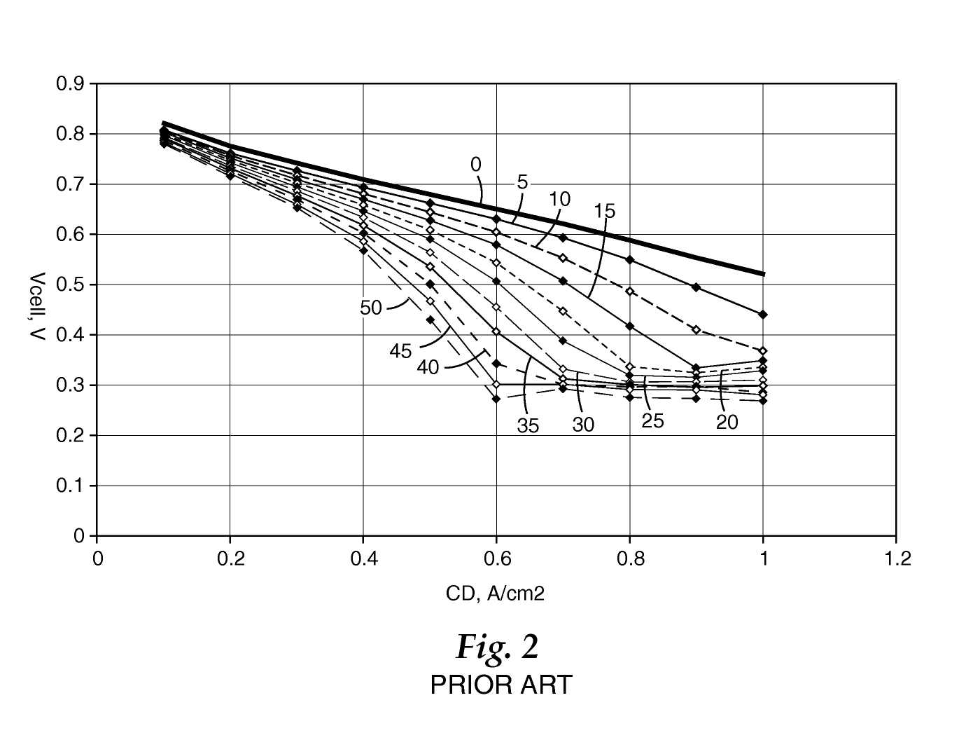

FIGS. 1 and 2 are graphs of polarization curves taken for MEA's of Example 1 and Comparative Example 3, respectively. The points on the polarization curves were measured at 60 second intervals. Each curve is labeled with the number of start-up/shut-down cycles undergone before the curve was measured. It can be readily seen that the MEA of Example 1 demonstrated much greater durability against start-stop decay. For an applied current of 0.6 A/cm², the MEA of Comparative Example 3 lost 350 mV after 50 cycles, compared to less than 20 mV loss for the MEA of Example 1.

Various modifications and alterations of this invention will become apparent to those skilled in the art without departing from the scope and principles of this invention, and it should be understood that this invention is not to be unduly limited to the illustrative embodiments set forth hereinabove.

We claim:

1. A method of making a fuel cell membrane electrode assembly comprising the steps of:
i) providing a polymer electrolyte membrane having first and second faces;
ii) providing a gas diffusion layer having a face;
iii) applying a second cathode catalyst layer to the face of the gas diffusion layer, the second cathode catalyst layer comprising a second cathode catalyst material and a second polymer electrolyte having a second equivalent weight;
iv) applying a first cathode catalyst layer to the second cathode catalyst layer, the first cathode catalyst layer comprising a first cathode catalyst material and a first polymer electrolyte having a first equivalent weight;
wherein the first cathode catalyst layer is more hydrophilic than the second cathode catalyst layer.

2. The method according to claim 1 wherein the first equivalent weight is less than the second equivalent weight.

3. The method according to claim 1 additionally comprising the step of:
v) applying an anode catalyst layer to the first face of the polymer electrolyte membrane.
